(19) United States
(12) Patent Application Publication
(10) Pub. No.: US 2023/0410684 A1
(43) Pub. Date: Dec. 21, 2023

(54) DETERMINING CONTENT BASED ON LIFE STAGE USING MACHINE LEARNING

(71) Applicant: Truist Bank, Charlotte, NC (US)

(72) Inventors: Ronald Lee Ratcliffe, JR., Garner, NC (US); Reinaldo Gamaliel Rivera Colon, Raleigh, NC (US); Jennifer Merten, Brookhaven, GA (US)

(73) Assignee: Truist Bank, Charlotte, NC (US)

(21) Appl. No.: 17/843,701

(22) Filed: Jun. 17, 2022

(51) Int. Cl. G09B 19/18; G06Q 20/40

(52) U.S. Cl. CPC G09B 19/18; G06Q 20/405

(57) ABSTRACT

Using machine learning for determining financial literacy content based on life stages is provided. For example, a computing system can determine a first stage of life associated with a first set of financial literacy content for a user account. The computing system can input a set of user characteristics associated with a user of the user account into a trained machine learning model. The computing system can receive, from the trained machine learning model, a second stage of life associated with the user. The second stage of life can be different than the first stage of life. The computing system can determine a second set of financial literacy content based on the second stage of life. The computing system can output, to a user device associated with the user account, the updated set of financial literacy content for display as a graphical user interface.

### TECHNICAL FIELD

The present disclosure relates to machine learning. More specifically, but not by way of limitation, this disclosure relates to determining financial literacy content based on life stages using machine learning.

### BACKGROUND

Online and mobile banking applications can allow users to interact with a financial institution's products and services by accessing their user account. In some cases, the products and services can include financial literacy content displayed on a graphical user interface that focuses on teaching and advising adults on financial literacy principles such as budgeting, investing, or saving. The financial literacy content can often include complex concepts that may be difficult for children to comprehend.

### SUMMARY

One example of the present disclosure includes a system comprising a processor and a non-transitory computer-readable memory. The non-transitory computer-readable memory can include instructions that are executable by the processor for causing the processor to perform operations. The operations can include determining a first stage of life associated with a first set of financial literacy content for a user account. The operations can include inputting a set of user characteristics associated with a user of the user account into a trained machine learning model. The operations can include receiving a second stage of life associated with the user from the trained machine learning model. The second stage of life can be different from the first stage of life. The operations can include determining a second set of financial literacy content based on the second stage of life. The operations can include outputting the second set of financial literacy content for display as a graphical user interface to a user device associated with the user account.

Another example of the present disclosure includes a method. The method can include determining, by a processor, a first stage of life associated with a first set of financial literacy content for a user account. The method can include inputting, by the processor, a set of user characteristics associated with a user of the user account into a trained machine learning model. The method can include receiving, by the processor, a second stage of life associated with the user from the trained machine learning model. The second stage of life can be different from the first stage of life. The methods can include determining, by the processor, a second set of financial literacy content based on the second stage of life. The method can include outputting, by the processor, the second set of financial literacy content for display as a graphical user interface to a user device associated with the user account.

Yet another example of the present disclosure includes a non-transitory computer-readable medium that comprises program code that is executable by the processor for causing the processor to perform operations. The operations can include determining a first stage of life associated with a first set of financial literacy content for a user account. The operations can include inputting a set of user characteristics associated with a user of the user account into a trained machine learning model. The operations can include receiving a second stage of life associated with the user from the trained machine learning model. The second stage of life can be different from the first stage of life. The operations can include determining a second set of financial literacy content based on the second stage of life. The operations can include outputting the second set of financial literacy content for display as a graphical user interface to a user device associated with the user account.

### BRIEF DESCRIPTION OF THE DRAWINGS

FIG. 1 is a block diagram of an example of a computing environment for using a trained machine learning model for updating financial literacy content according to some aspects of the present disclosure.

FIG. 2 is a block diagram of an example of a graphical user interface for displaying updated financial literacy content in a virtual reality environment according to some aspects of the present disclosure.

FIG. 3 is a block diagram of an example of a server for using a trained machine learning model for updating financial literacy content according to some aspects of the present disclosure.

FIG. 4 is a flowchart illustrating an example of a process for using a trained machine learning model for updating financial literacy content according to some aspects of the present disclosure.

### DETAILED DESCRIPTION

Certain aspects and features relate to using a trained machine learning model to determine life stages for updating financial literacy content. For example, financial institutions may have databases of financial literacy content directed towards teaching and advising people about financial principles. Financial literacy content may be displayed on applications that are accessible via user accounts. But some financial literacy content may not be applicable to certain users. And, some users may not have access to certain financial literacy content that may be applicable to their stage of life. To better customize financial literacy content for users, user characteristics for a user can be inputted into a trained machine learning model. The trained machine learning model can output a stage of life for the user. For example, the trained machine learning model can output a life stage of preparing to buy a house. Based on the determined stage of life, targeted financial literacy content can be outputted for display on a graphical user interface for the user.

In some examples, the graphical user interface can be a virtual reality environment. The virtual reality environment can be associated with and personalized according to the user account. For example, the targeted financial literacy content can be incorporated into teaching elements within the virtual reality environment. The teaching elements can include interactive gaming elements or visualization elements for displaying user account information as well as incorporating the targeted financial literacy content. The interactive gaming elements can include games directed to teaching the targeted financial literacy content in an easily understandable and visually appealing manner. The visualization elements can include diagrams displaying proportions or amounts of money that have been spent, saved, or earned from the user account. The diagrams can be pie charts, graphs, cartoons, or any other type of diagram or visual element. The diagrams can include the targeted financial literacy content. For example, a diagram of student loan debt for the user account can include targeted financial literacy content relating to methods for paying off student loans.

These illustrative examples are given to introduce the reader to the general subject matter discussed here and are not intended to limit the scope of the disclosed concepts. The following sections describe various additional features and examples with reference to the drawings in which like numerals indicate like elements.

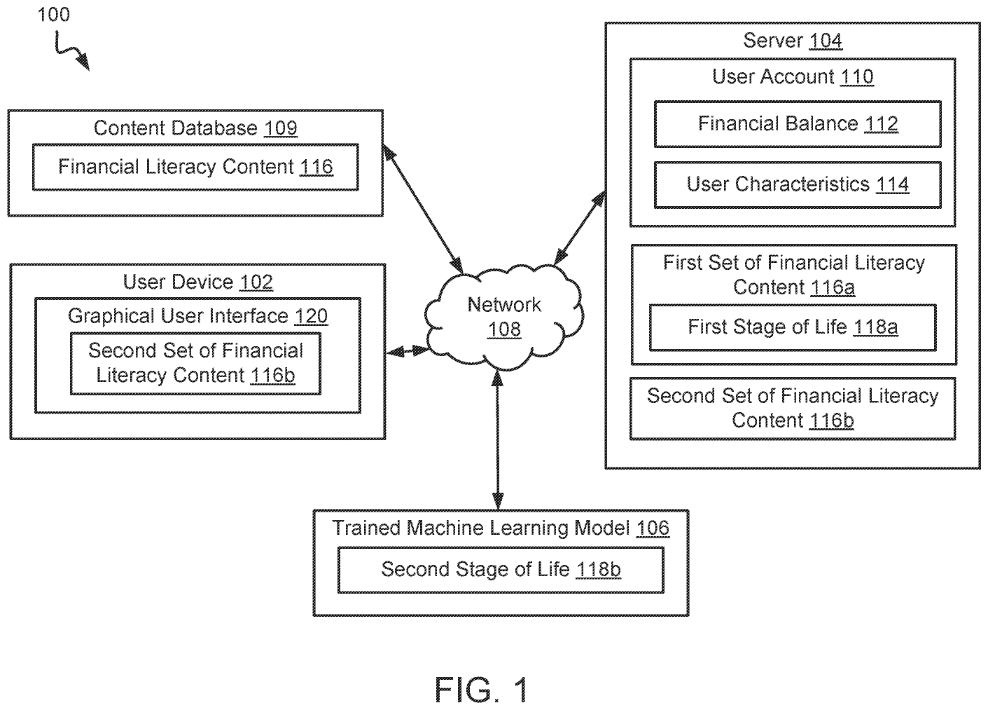

FIG. 1 is a block diagram of an example of a computing environment 100 for using a trained machine learning model 106 for updating financial literacy content according to some aspects of the present disclosure. The computing environment 100 can include a user device 102, a server 104, a trained machine learning model 106, and a content database 109 communicatively coupled via a network 108. Each communication within the computing environment 100 may occur over one or more data networks, such as a public data network, a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). Examples of user devices can include desktop computers, videogame consoles, mobile phones (e.g., cellular phones), PDAs, tablet computers, net books, laptop computers, hand-held specialized readers, and wearing devices such as smart watches.

The computing environment 100 can include a content database 109 storing various types of financial literacy content 116. Examples of financial literacy content 116 can include content directed to taking out loans (such as student loans, home loans, car loans, or personal loans), investing funds, setting up different accounts (such as savings accounts or checking accounts), credit cards, retirement funds, reducing debt, donating funds, budgeting, and more. Some financial literacy content 116 may be more or less applicable to certain users of user accounts. For example, a user who is a college student may find financial literacy content 116 directed to managing student loans more useful than financial literacy content 116 directed to buying a home.

The server 104 can include a user account 110 for a particular user. The user account 110 may be a financial account that includes a financial balance 112. The server 104 can generate a graphical user interface 120 displaying financial literacy content 116 for a user device 102 associated with the user. In some examples, the financial literacy content 116 displayed on the user device 102 may be directed to a stage of life 118 that differs from the user. For example, a first set of financial literacy content 116a can be directed to a first stage of life 118a. The server 104 can determine that the first stage of life 118a for the financial literacy content 116a may not be directed to the same stage of life 118 as the user. To determine a more appropriate set of financial literacy content 116 to be displayed for the user, the server 104 can determine user characteristics 114 relating to the user. In some examples, the server 104 may receive user characteristics 114 from the user device 102. Examples of the user characteristics 114 can include an age, a location, a marital status, an educational background, a parental status, and an occupation of the user.

Additionally or alternatively, the server 104 can determine the user characteristics 114. The server 104 may determine the user characteristics 114 based on user activity observations collected from the user interacting with the user account 110 on the user device 102. For example, the user activity observations can include changes to the financial balance 112 in the user account 110, new accounts (e.g., checking accounts, savings accounts, investment accounts) being opened, or searches for particular financial literacy content on an application that includes the user account 110. The user activity observations can also include merchant codes associated with transactions from the user account 110.

The server 104 can input the user characteristics 114 into a trained machine learning model 106. The trained machine learning model 106 can output a second stage of life 118b based on the user characteristics 114. The trained machine learning model 106 can be generated by training a machine learning model with sets of user characteristics 114 and sets of life stages 118. Examples of life stages 118 can include a high school student stage, a college student stage, an early career stage, a wedding planning stage, a family planning stage, a home buying stage, a career transition stage, a retirement planning stage, and more. Examples of the trained machine learning model can include a neural network, a Naive Bayes classifier, or a support vector machine.

The server 104 can determine a second set of financial literacy content 116b based on the second stage of life 118b outputted by the trained machine learning model 106. For example, the server 104 can identify the second set of financial literacy content 116b from within the content database 109. In some examples, the sets of financial literacy content 116 in the content database 109 may be tagged with various life stages 118. The server 104 may determine the second set of financial literacy content 116 within the content database 109 by identifying tags associated with the second stage of life 118b. The server 104 may then generate an updated graphical user interface 120 that includes the second set of financial literacy content 116b. The server 104 can output the graphical user interface 120 to the user device 102. In some examples, the server 104 can input the user characteristics 114 into the trained machine learning model 106 in response to determining a change in the user characteristics 114. The change in the user characteristics 114 may indicate that the user is moving into a different or additional life stage. The graphical user interface 120 can therefore be continually updated over time. The user may experience increased understanding and comprehension of the second set of financial literacy content 116b as compared to the first set of financial literacy content 116a.

The numbers of devices depicted in FIG. 1 are provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the trained machine learning model 106 and the server 104, may instead be implemented in a single device or system.

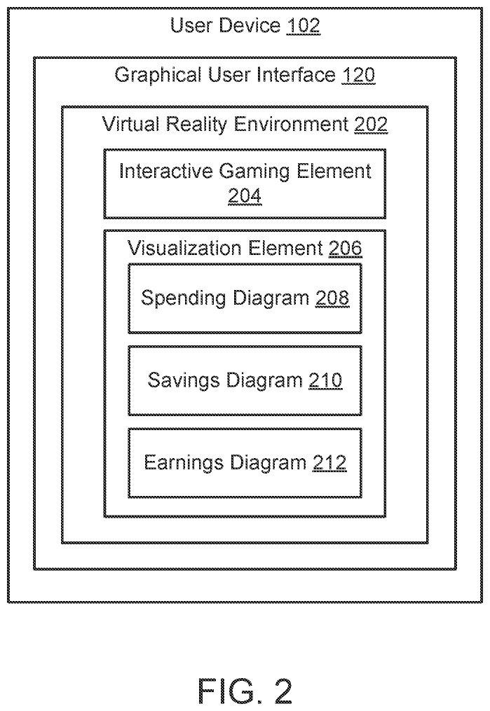

In some examples, the graphical user interface 120 can include a virtual reality environment 202 for displaying the second set of financial literacy content 116b. FIG. 2 is a block diagram of an example of a graphical user interface 120 for displaying updated financial literacy content 116 in a virtual reality environment 202 according to some aspects of the present disclosure. The graphical user interface 120 can be displayed on the user device 102 from FIG. 1. In some examples, the user device 102 can include a virtual reality headset that is communicatively coupled to the user device 102. The server 104 can generate a virtual reality environment 202 for the user account 110 and can transmit the virtual reality environment 202 to the user device 102 for display. For example, the virtual reality headset may render the virtual reality environment 202 for display to the user. In some examples, the user device 102 can include a controller in communication with the virtual reality environment 202 for receiving input from a user of user device 102, or for providing sensory output to the user of the user device 102.

The virtual reality environment 202 can include teaching elements relating to financial literacy concepts. The teaching elements can include an interactive gaming element 204 that a user can interact with using the user device 102. In some examples, the virtual reality environment 202 can mimic reality. For example, the interactive gaming element 204 may be a game simulating a job. The user may play as a chef, a mailman, a detective, or any other job to earn virtual credits. In some examples, the interactive gaming element 204 may include educational games related to financial literacy. For example, the educational games may include a testing element for testing a user's knowledge of financial literacy. The user can interact with the interactive gaming element 204 on the user device to send gaming inputs 122 to the server 104, such as with the virtual reality headset or controller. The second set of financial literacy content 116b described above in relation to FIG. 1 can be incorporated into the interactive gaming element 204. For example, the educational games may be based on the second set of financial literacy content 116b.

In some examples, the virtual reality environment 202 can include visualization elements 206 that can provide information to the user about their particular user account 110 as a tool for teaching financial literacy. For example, the visualization elements 206 can include spending diagrams 208, savings diagrams 210, earnings diagrams 212, or any other diagrams for displaying the financial balance 112 in the user account 110. In some examples, the visualization element 206 or the interactive gaming element 204 can include personalized content based on the spending, saving, and earning characteristics of the user account 110. For example, if the user account 110 is primarily used for spending with low earnings and little to no saving, the virtual reality environment 202 can include content directed towards encouraging the user to increase savings or earnings. The second set of financial literacy content 116b can also be incorporated into the visualization elements 206. For example, a chart depicting progress towards a savings goal can include the second set of financial literacy content 116b directed to explaining helpful savings principles.

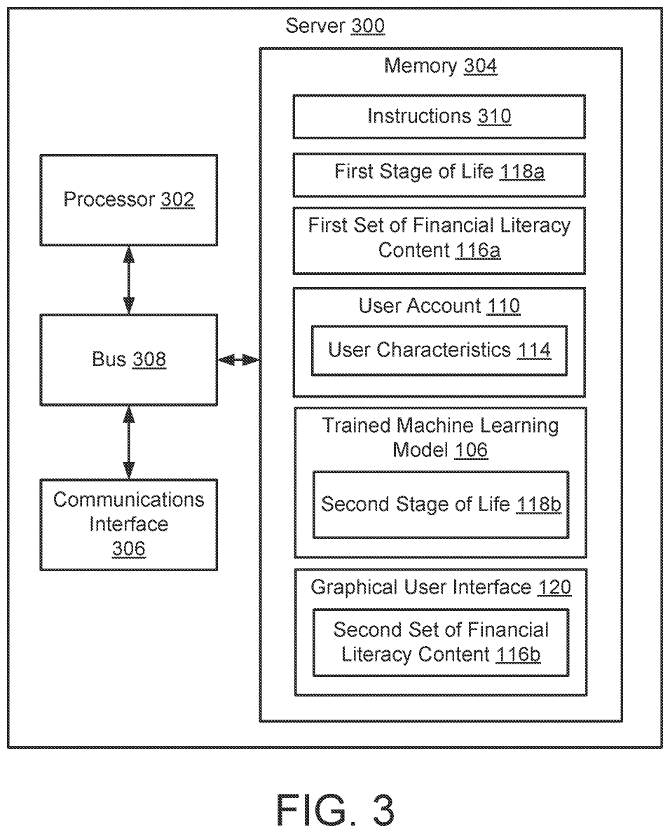

FIG. 3 is a block diagram of an example of a server 300 for using a trained machine learning model 106 for updating financial literacy content 116 according to some aspects of the present disclosure. For example, the server 300 may be used as the server 104 from FIG. 1. The server 300 can include a processor 302, a memory 304, and a communications interface 306 that are communicatively connected via a bus 308. In some examples, the components shown in FIG. 3 can be integrated into a single structure. For example, the components can be within a single housing. In other examples, the components shown in FIG. 2 can be distributed (e.g., in separate housings) and in electrical communication with each other.

The processor 302 can execute one or more operations for implementing some examples. The processor 302 can execute instructions 310 stored in the memory 304 to perform the operations. The processor 302 can include one processing device or multiple processing devices. Non-limiting examples of the processor 302 include a Field-Programmable Gate Array (“FPGA”), an application-specific integrated circuit (“ASIC”), a microprocessor, etc.

The processor 302 can be communicatively coupled to the memory 304. The non-volatile memory 304 may include any type of memory device that retains stored information when powered off. Non-limiting examples of the memory 304 include electrically erasable and programmable read-only memory (“EEPROM”), flash memory, or any other type of non-volatile memory. In some examples, at least some of the memory 304 can include a medium from which the processor 302 can read instructions. A computer-readable medium can include electronic, optical, magnetic, or other storage devices capable of providing the processor 302 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C #, etc.

The memory 304 can include a first set of financial literacy content 116a associated with a first stage of life 118a. The memory 304 can also include a user account 110 such as a financial account. The user account 110 can include user characteristics 114 relating to a user of the user account. In some examples, the user may be in a different stage of life than the first stage of life 118a. To determine an updated stage of life and associated financial literacy content, the processor 302 can input the user characteristics 114 into a trained machine learning model 106. The trained machine learning model 106 can output a second stage of life 118b. The processor 302 can determine a second set of financial literacy content 116b associated with the second stage of life 118b. The processor 302 can generate a graphical user interface 120 for the user account 110 that includes the second set of financial literacy content 116b. The processor 302 can output the graphical user interface 120 via the communications interface 306 for display on a user device, such as the user device 102 depicted in FIG. 1.

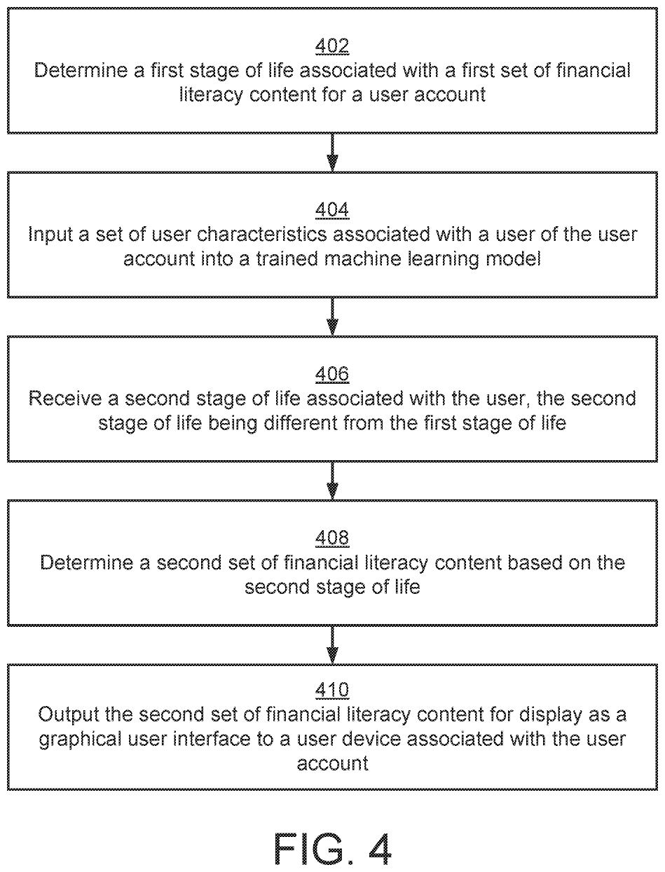

FIG. 4 is a flowchart illustrating an example of a process for using a trained machine learning model for updating financial literacy content according to some aspects of the present disclosure. The process of FIG. 4 can be implemented by the computing environment 100 of FIG. 1, the user device 102 of FIG. 2, or the server 300 of FIG. 3, but other implementations are also possible.

At block 402, the processor 302 can determine a first stage of life 118a associated with a first set of financial literacy content 116a for a user account 110. For example, the first set of financial literacy content 116a may originate from a content database 109. The processor 302 may determine the first stage of life 118a associated with the first set of financial literacy content 116a based on a database tag for the first set of financial literacy content 116a. In one particular example, the first stage of life 118a may be a college student stage. At block 404, the processor 302 can input a set of user characteristics 114 associated with a user of the user account 110 into a trained machine learning model 106. In some examples, the processor 302 can input the set of user characteristics 114 into the trained machine learning model 106 in response to determining a change in user characteristics associated with the user account 110. For example, the change in user characteristics can include identifying a new direct deposit added to the user account 110. The trained machine learning model 106 can be generated by training a machine learning model using sets of user characteristics associated with sets of life stages.

At block 406, the processor 302 can receive a second stage of life 118b associated with the user from the trained machine learning model 106. The second stage of life 118b may be different from the first stage of life 118a. The second stage of life 118b may be more applicable to the user than the first stage of life 118a. For example, the second stage of life 118b may be a home buying stage. At block 408, the processor 302 can determine a second set of financial literacy content 116b based on the second stage of life 118b. For example, the processor 302 can search the content database 109 to identify a second set of financial literacy content 116b that relates to mortgages, buying a house, calculating mortgage payments, home-buying assistance programs, or any other content related to a home buying stage.

At block 410, the processor 302 can output the second set of financial literacy content 116b for display as a graphical user interface 120. In some examples, the graphical user interface 120 can include a virtual reality environment 202 that includes the second set of financial literacy content 116b. The processor 302 can generate the virtual reality environment 202 and can output the virtual reality environment 202 for display to the user device 102. In some examples, generating the virtual reality environment 202 can include generating an interactive gaming element 204 or a visualization element 206. The second set of financial literacy content 116b can be incorporated into the interactive gaming element 204 and the visualization element 206.

The foregoing description of certain examples, including illustrated examples, has been presented only for the purpose of illustration and description and is not intended to be exhaustive or to limit the disclosure to the precise forms disclosed. Numerous modifications, adaptations, combinations, and uses thereof are possible without departing from the scope of the disclosure.

What is claimed is:

1. A system comprising:
a processor; and
a non-transitory computer-readable memory comprising instructions that are executable by the processor for causing the processor to:
determine a first stage of life associated with a first set of financial literacy content for a user account;
input a set of user characteristics associated with a user of the user account into a trained machine learning model;
receive, from the trained machine learning model, a second stage of life associated with the user, the second stage of life being different from the first stage of life;
determine a second set of financial literacy content based on the second stage of life; and
output, to a user device associated with the user account, the second set of financial literacy content for display as a graphical user interface.

2. The system of claim 1, wherein the memory further comprises instructions that are executable by the processor for causing the processor to input the set of user characteristics associated with the user of the user account into the trained machine learning model in response to:
determining a change in the set of user characteristics.

3. The system of claim 1, wherein the memory further comprises instructions that are executable by the processor for causing the processor to:
generate the trained machine learning model by training a machine learning model using sets of user characteristics associated with sets of life stages.

4. The system of claim 1, wherein the set of user characteristics includes an age, a location, a marital status, an educational background, a parental status, and an occupation of the user.

5. The system of claim 1, wherein the memory further comprises instructions that are executable by the processor for causing the processor to output the second set of financial literacy content for display as the graphical user interface by:
generating a virtual reality environment associated with the user account, the virtual reality environment comprising the second set of financial literacy content; and
outputting the virtual reality environment for display to the user device.

6. The system of claim 5, wherein the memory further comprises instructions that are executable by the processor for causing the processor to generate the virtual reality environment by:
generating an interactive gaming element in the virtual reality environment, the interactive gaming element comprising the second set of financial literacy content.

7. The system of claim 5, wherein the memory further comprises instructions that are executable by the processor for causing the processor to generate the virtual reality environment by:
generating a visualization element based on a financial balance associated with the user account and the second set of financial literacy content, the visualization element comprising a spending diagram, a savings diagram, and an earnings diagram; and
outputting the visualization element for display in the virtual reality environment.

8. A method comprising:
determining, by a processor, a first stage of life associated with a first set of financial literacy content for a user account;
inputting, by the processor, a set of user characteristics associated with a user of the user account into a trained machine learning model;
receiving, by the processor, a second stage of life associated with the user from the trained machine learning model, the second stage of life being different from the first stage of life;
determining, by the processor, a second set of financial literacy content based on the second stage of life; and
outputting, by the processor, the second set of financial literacy content for display as a graphical user interface to a user device associated with the user account.

9. The method of claim 8, wherein the method further comprises inputting the set of user characteristics associated with the user of the user account into the trained machine learning model in response to:
determining a change in the set of user characteristics.

10. The method of claim 8, further comprising:
generating the trained machine learning model by training a machine learning model using sets of user characteristics associated with sets of life stages.

11. The method of claim 8, wherein the set of user characteristics includes an age, a location, a marital status, an educational background, a parental status, and an occupation of the user.

12. The method of claim 8, wherein the method further comprises outputting the second set of financial literacy content for display as the graphical user interface by:
generating a virtual reality environment associated with the user account, the virtual reality environment comprising the second set of financial literacy content; and
outputting the virtual reality environment for display to the user device.

13. The method of claim 12, wherein the method further comprises generating the virtual reality environment by:
generating an interactive gaming element in the virtual reality environment, the interactive gaming element comprising the second set of financial literacy content.

14. The method of claim 12, wherein the method further comprises generating the virtual reality environment by:
generating a visualization element based on a financial balance associated with the user account and the second set of financial literacy content, the visualization element comprising a spending diagram, a savings diagram, and an earnings diagram; and
outputting the visualization element for display in the virtual reality environment.

15. A non-transitory computer-readable medium comprising program code that is executable by a processor for causing the processor to:
determine a first stage of life associated with a first set of financial literacy content for a user account;
input a set of user characteristics associated with a user of the user account into a trained machine learning model;
receive, from the trained machine learning model, a second stage of life associated with the user, the second stage of life being different from the first stage of life;
determine a second set of financial literacy content based on the second stage of life; and
output, to a user device associated with the user account, the second set of financial literacy content for display as a graphical user interface.

16. The non-transitory computer-readable medium of claim 15, wherein the program code is further executable by the processor for causing the processor to input the set of user characteristics associated with the user of the user account into the trained machine learning model in response to:
determining a change in the set of user characteristics.

17. The non-transitory computer-readable medium of claim 15, wherein the program code is further executable by the processor for causing the processor to:
generate the trained machine learning model by training a machine learning model using sets of user characteristics associated with sets of life stages.

18. The non-transitory computer-readable medium of claim 15, wherein the set of user characteristics includes an age, a location, a marital status, an educational background, a parental status, and an occupation of the user.

19. The non-transitory computer-readable medium of claim 15, wherein the program code is further executable by the processor for causing the processor to output the second set of financial literacy content for display as the graphical user interface by:
generating a virtual reality environment associated with the user account, the virtual reality environment comprising the second set of financial literacy content; and
outputting the virtual reality environment for display to the user device.

20. The non-transitory computer-readable medium of claim 19, wherein the program code is further executable by the processor for causing the processor to generate the virtual reality environment by:
generating an interactive gaming element in the virtual reality environment, the interactive gaming element comprising the second set of financial literacy content.
